(19) United States
(12) Patent Application Publication
(10) Pub. No.: US 2012/0013943 A1
(43) Pub. Date: Jan. 19, 2012

(54) IMAGE FORMING APPARATUS, INFORMATION PROCESSING APPARATUS, PRINTING SYSTEM, IMAGE FORMING METHOD, IMAGE FORMING PROGRAM, AND STORAGE MEDIUM STORING IMAGE FORMING PROGRAM

(75) Inventor: Koki Shibao, Yokohama-shi (JP)

(73) Assignee: CANON KABUSHIKI KAISHA, Tokyo (JP)

(21) Appl. No.: 13/133,132

(22) PCT Filed: Mar. 1, 2011
(86) PCT No.: PCT/JP11/55182

§ 371 Date: Jun. 6, 2011

(30) Foreign Application Priority Data
Mar. 4, 2010 (JP) 2010-048047

(51) Int. Cl. G06K 15/02

(52) U.S. Cl. 358/1.15

(57) ABSTRACT

An image forming apparatus sends an information processing apparatus an image processing function selected from image processing functions that the image forming apparatus has and an image processing function selected from image processing functions that the information processing apparatus has, and receives a result that is determined by the information processing apparatus according to a conflict determination condition.

### TECHNICAL FIELD

The present invention relates to an image forming apparatus that processes and prints image data, an information processing apparatus that can perform image processing as an external apparatus of the image forming apparatus, a printing system consisting of the image forming apparatus and the information processing apparatus, an image forming method executed in the image forming apparatus, an image forming program causing a computer to execute the method, and a storage medium storing the program.

### BACKGROUND ART

Generally, an image forming apparatus like a printer is equipped with various functions (print processing functions), and one of these functions is what is called an N-in-1 copy function that combines images on original sheets to one sheet and prints. These functions include an inserting function that prints pages by inserting an insertion sheet between specific pages, and a superimposing function that superimposes a specific image on an original image and outputs. Then, the image forming apparatus can singly print while combining a plurality of print processing functions represented by the above-mentioned functions.

On the other hand, a printing system where an external apparatus (an information processing apparatus) like a personal computer achieves a print processing function with which an image forming apparatus is not provided is proposed.

For example, the image forming apparatus disclosed in PTL 1 sends a request and image data of an inputted original to an external apparatus when a user requests a predetermined function through an operation panel (an operation unit) that the image forming apparatus equips. The image forming apparatus receives the image data processed by the external apparatus and prints according to the processed image data.

A storage unit that the image forming unit equips stores a program (a control program) for controlling the operation unit corresponding to the image processing functions that the external apparatus has and screen resources for displaying on the operation unit. Accordingly, when the image processing function with which the external device is provided is upgraded, it is necessary to also upgrade the control program and the screen resources of the image forming apparatus. In other words, the program with which the image forming apparatus is equipped is dependent on the functions (i.e., programs) of the external apparatus.

On the other hand, PTL 2 discloses a technique where a Web page of an external apparatus is displayed on an operation panel of an image forming apparatus and various applications are executed in response to operations on the Web page. In this case, an image formation program held in the image forming apparatus operates with linking to these applications. The applications, screen resources for inputting parameters with respect to the applications, etc. are stored in a storage unit of the external apparatus.

Therefore, it becomes possible to upgrade the applications of external apparatus independently of the program of the image forming apparatus. However, the function that the application achieves cannot be used in combination with the print processing function with which the image forming apparatus is provided. That is, the function of the external apparatus and the function of the image forming apparatus cannot be operated in cooperation.

### CITATION LIST

### Patent Literature

PTL 1: Japanese Laid-Open Patent Publication (Kokai) No. 2003-288336 (JP2003-288336A)
PTL 2: Japanese Laid-Open Patent Publication (Kokai) No. 2008-139981 (JP2008-139981A)

### SUMMARY OF INVENTION

### Technical Problem

In order to solve the above-mentioned problems, programs of the external apparatus and programs of the image forming apparatus need to be upgraded independently, and functions of both the apparatuses need to combine for printing. However, the following new problem arises.

When extending the function of the image forming apparatus using the external apparatus, the external apparatus generates a UI (user interface) screen for an extended function, and displays the UI screen on the image forming apparatus as a Web page, for example. In this case, while the external apparatus expands a function independently, the image forming apparatus cannot know what function will be extended in advance.

Therefore, a UI program used in the image forming apparatus cannot define a prohibition beforehand about combinations (conflicts) of the extended function provided from the external apparatus and the function with which the image forming apparatus is provided. That is, even if the extended function provided from the external apparatus and the image processing function with which the image forming apparatus is provided form a combination that cannot be executed simultaneously, a user does not become aware that the above-mentioned combination is unsuitable until an error occurs or an unexpected image is outputted as a result of execution of the print job.

In view of such inconvenience, it is conceivable that any print processing functions (they are also called image processing functions) with which the image forming apparatus is provided are also displayed on the UI screen that the external apparatus provides together with the other functions and that a prohibition process is performed with the UI screen concerned (a combination of functions that cannot be executed simultaneously is eliminated). It is also considered that all the available combinations of the image processing functions are displayed on the UI screen.

However, a user may get confused when the same setting items are displayed on the both sides of the UI screen of the image forming apparatus and the UI screen of the external apparatus. There is a further problem that operability becomes worse for a user who grew familiar with the UI screen which an image forming apparatus provides, and was familiar with it.

The present invention provides an image forming apparatus, an information processing apparatus, a printing system, an image forming method, an image forming program, and a storage medium storing the program, which are capable of improving operability for a user when setting an image processing function via a UI screen.

### Solution to Problem

Accordingly, a first aspect of the present invention provides an image forming apparatus having print processing functions that is connected to an information processing apparatus that has image processing functions via a network, comprising a first setting means that sets a setting parameter, when at least one of the print processing functions is selected, concerning the selected print processing function as an internal setting parameter, a second setting means that sets a setting parameter, when at least one of the image processing functions is selected, concerning the selected image processing function as an external setting parameter, a first sending means that sends the internal setting parameter and the external setting parameter to the information processing apparatus, and a stopping means that stops the printing process that uses the selected print processing function and the selected image processing function, when receiving a prohibition notice, which shows that the selected print processing function and the selected image processing function cannot be used in combination, as a determination result determined by the information processing apparatus according to the internal setting parameter, the external setting parameter, and a predetermined conflict determination condition.

Accordingly, a second aspect of the present invention provides an information processing apparatus having image processing functions comprising a connecting means that connects to an image forming apparatus that forms an image selectively using print processing functions, a reception means that receives an internal setting parameter concerning the print processing function and an external setting parameter concerning the image processing function from the image forming apparatus, a determination means that determines whether the print processing function and the image processing function can be used in combination according to the internal setting parameter, the external setting parameter, and a predetermined conflict determination condition, and a sending means that sends a determination result by the determination means to the image forming apparatus.

Accordingly, a third aspect of the present invention provides A printing system comprising the image forming apparatus according to the first aspect, and the information processing apparatus according to the second aspect.

Accordingly, a fourth aspect of the present invention provides an image forming method for an image forming apparatus having print processing functions that is connected to an information processing apparatus that has image processing functions via a network, the method comprising a first setting step of setting a setting parameter, when at least one of the print processing functions is selected, concerning the selected print processing function as an internal setting parameter, a second setting step of setting a setting parameter, when at least one of the image processing functions is selected, concerning the selected image processing function as an external setting parameter, a sending step of sending the internal setting parameter and the external setting parameter to the information processing apparatus, and a stopping step of stopping the printing process that uses the selected print processing function and the selected image processing function, when receiving a prohibition notice, which shows the selected print processing function and the selected image processing function cannot be used in combination, as a determination result determined by the information processing apparatus according to the internal setting parameter, the external parameter, and a predetermined conflict determination condition.

Accordingly, a fifth aspect of the present invention provides an image forming program causing a computer to execute an image forming method for an image forming apparatus having print processing functions that is connected to an information processing apparatus that has image processing functions via a network, the method comprising a first setting step of setting a setting parameter, when at least one of the print processing functions is selected, concerning the selected print processing function as an internal setting parameter, a second setting step of setting a setting parameter, when at least one of the image processing functions is selected, concerning the selected image processing function as an external setting parameter, a sending step of sending the internal setting parameter and the external setting parameter to the information processing apparatus, and a stopping step of stopping the printing process that uses the selected print processing function and the selected image processing function, when receiving a prohibition notice, which shows the selected print processing function and the selected image processing function cannot be used in combination, as a determination result determined by the information processing apparatus according to the internal setting parameter, the external parameter, and a predetermined conflict determination condition.

Accordingly, a sixth aspect of the present invention provides a non-transitory computer-readable storage medium storing the image forming program according to the fifth aspect.

Accordingly, a seventh aspect of the present invention provides an image forming apparatus that has image processing functions, forms an image using the image forming functions, and is connectable to an information processing apparatus having image processing functions, comprising a first selection unit that selects at least one of the image processing functions that the image forming apparatus has, a second selection unit that selects at least one of the image processing functions that the information processing apparatus has, a sending unit that sends information showing the image processing function selected by the first selection unit and the image processing function selected by the second selection unit to the information processing apparatus, a reception unit that receives a determination result, which is determined by the information processing apparatus according to the information sent by the sending unit and a predetermined conflict determination condition, from the information processing apparatus, and a display unit that displays a message according to the determination result received by the reception unit.

### Advantageous Effects of Invention

According to the present invention, regardless of what information processing function is provided by the information processing apparatus, the prohibition process can be executed between the image forming apparatus and the information processing apparatus, even if the information processing apparatus provides any image processing functions. Therefore, failures in image output decrease, which enables to ensure the printing process. As a result, the operability for a user when setting an image processing function via the UI screen is improved.

Further features of the present invention will become apparent from the following description of exemplary embodiments with reference to the attached drawings.

### BRIEF DESCRIPTION OF DRAWINGS

FIG. 1 is a functional block diagram schematically showing an example of a printing system using an image processing apparatus according to a first embodiment of the present invention.

FIG. 2 is a view showing an example of a job setting screen displayed on an operation unit of the image forming apparatus shown in FIG. 1.

FIG. 3 is a view showing an example of prohibition when a job setting is performed on the job setting screen shown in FIG. 2.

FIG. 4A is a view showing another example of prohibition when a job setting is performed on the job setting screen shown in FIG. 2.

FIG. 4B is a view showing an example of a process according to the job set up on the job setting screen shown in FIG. 4A.

FIG. 5 is a flowchart showing a job setting process in the image forming apparatus shown in FIG. 1.

FIG. 6 is a flowchart showing an extension setting process executed in the step S1005 in FIG. 5.

FIG. 7 is a flowchart showing a control process in an external apparatus shown in FIG. 1.

FIG. 8 is a flowchart showing a process for storing information about the image forming apparatus into the external apparatus shown in FIG. 1.

FIG. 9 is a view showing an example of received data described in FIG. 8 in detail.

FIG. 10 is a flowchart showing a prohibition process and a supplementary setting in the external apparatus shown in FIG. 1.

FIG. 11 is a view showing an example of a conflict determination condition stored in a storage unit of the external apparatus shown in FIG. 1.

FIG. 12 is a flowchart showing an original reading task executed in the step S1013 in FIG. 5.

FIG. 13 is a flowchart showing an output task executed in the step S1014 in FIG. 5 in detail.

FIG. 14 is a flowchart showing an image processing in the external apparatus shown in FIG. 1.

FIG. 15 is a flowchart showing job setting in the image forming apparatus shown in FIG. 1 in a printing system according to a second embodiment of the present invention.

FIG. 16 is a flowchart showing a process in the external apparatus shown in FIG. 1 in the printing system according to the second embodiment of the present invention.

### DESCRIPTION OF EMBODIMENTS

Hereafter, an image processing apparatus and a printing system using the image processing apparatus according to embodiments of the present invention will be described with reference to drawings.

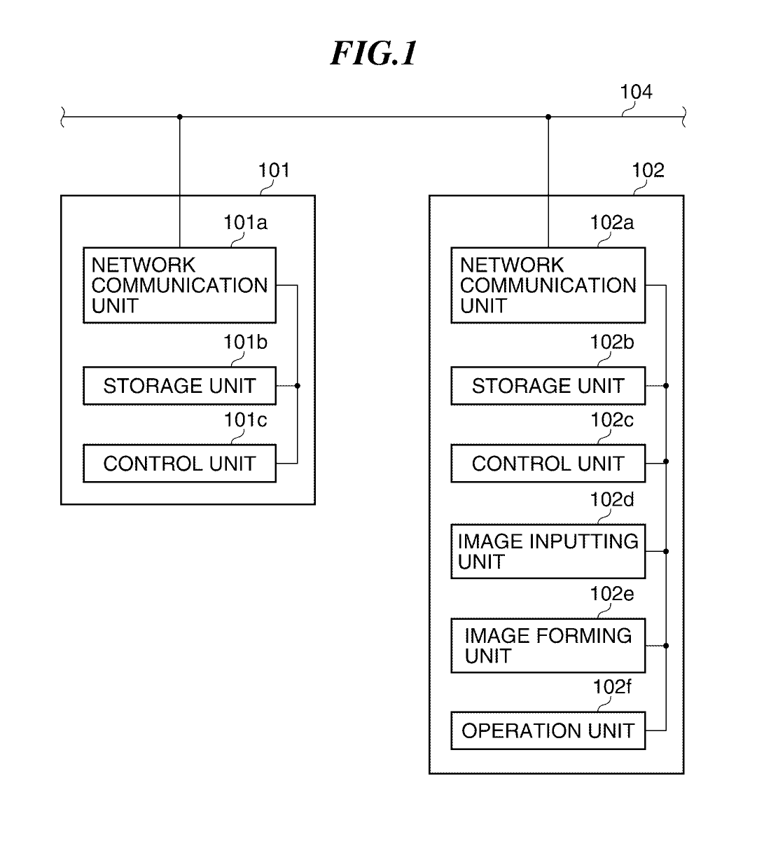

FIG. 1 is a functional block diagram schematically showing an example of the printing system using the image processing apparatus according to a first embodiment of the present invention.

As shown in FIG. 1, the illustrated printing system has an external apparatus 101 and the image forming apparatus 102. The external apparatus 101 and the image forming apparatus 102 are mutually connected via a network 104. The external apparatus 101 is an information processing apparatus like a desktop PC (personal computer) or a notebook PC, for example.

A wired LAN (local area network) or a wireless LAN is used as the network 104, for example. It should be noted that the Internet may be used as the network 104 to connect the external apparatus 101 and the image forming apparatus 102.

The external apparatus 101 is provided with a CPU (a central arithmetic unit), a ROM, a RAM, and a HDD (a hard disk drive), for example, as a hardware configuration (not shown in FIG. 1). Then, the CPU reads programs, image data required for each program, and Web page contents, which are stored in the HDD, onto the RAM and executes them.

The external apparatus 101 has a network communication unit 101a, a storage unit 101b, and a control unit 101c. The network communication unit 101a sends/receives image data, a Web page, etc. to/from the image forming apparatus 102 via the network 104. The network communication unit 101a is a function with which the CPU is equipped, for example.

The storage unit 101b is achieved by the above-mentioned ROM, RAM, HDD, etc. The storage unit 101b stores information like Web page contents, a control program, for example.

The control unit 101c is achieved by the CPU and executes the control program read from the storage unit 101b. The control unit 101c sends the Web page to the image forming apparatus 102, when a Web page is requested from the image forming apparatus 102. The control unit 101c receives a set value inputted into the Web page displayed on the image forming apparatus 102 from the image forming apparatus 102, and stores it to the storage unit 101b.

The control unit 101c stores the image data (called internal image data) received from the image forming apparatus 102 into the storage unit 101b. In addition, the control unit 101c reads the set value and the internal image data that will be mentioned below, and applies an image processing to the internal image data according to the set value concerned (the image data processed is hereafter called external image data). Then, the control unit 101c sends the external image data to the image forming apparatus 102 via the network communication unit 101a.

It should be noted that the HTTP, which is suitable for transmissions/receptions of a Web page request and a Web page, or the SOAP, which is suitable for transmission/reception of a control instruction, can be used as a communication method between the external apparatus 101 and the image forming apparatus 102.

Similarly, the image forming apparatus 102 has a CPU, a ROM, a RAM, a HDD, etc. as a hardware configuration. Then, the CPU reads programs, image data required for each program, screen resources, etc., which are stored in the HDD, onto the RAM and executes them.

The image forming apparatus 102 has a network communication unit 102a, a storage unit 102b, a control unit 102c, an image input unit 102d, an image forming unit 102e, and an operation unit 102f. In the illustrated example, the network communication unit 102a, the storage unit 102b, the control unit 102c, and the operation unit 102f constitute the image processing apparatus.

The network communication unit 102a sends/receives image data, a Web page, etc. to/from the external apparatus 101. The network communication unit 102a is a function with which the CPU is equipped, for example.

The storage unit 102b is achieved by the ROM, the RAM, the HDD, etc., and the information about a control program, etc. is stored in the storage unit 102b.

The control unit 102c is achieved by the CPU and executes the control program read from the storage unit 102b. The control unit 102c displays a job setting screen that is different from a Web page on the operation unit 102f, and stores a set value inputted through the job setting screen to the storage unit 102b. The control unit 102c receives the Web page required of the external apparatus 101 via the network communication unit 102a, displays it on the operation unit 102f, and sends the inputted set value via the Web page to the external apparatus 101.

When receiving a print start instruction from the operation unit 102f, the control unit 102c generates a print job as mentioned later. Then, the control unit 102c stores the image data read by the image input unit 102d into the storage unit 102b as the internal image data.

When the control unit 102c sends the image data to the external apparatus 101, the control unit 102c reads the image data from the image input unit 102d. The control unit 102c applies the image processing to the image data according to the set value inputted from the operation unit 102f, and sends the data as the internal image data to the external apparatus 101.

The control unit 102c receives the external image data from the external apparatus 101 via the network communication unit 102a, and stores it to the storage unit 102b.

On the other hand, the control unit 102c may send the image data read by the image input unit 102d to the external apparatus 101 as the internal image data. In this case, the external apparatus 101 applies the image processing to the internal image data, and sends the data to the image forming apparatus 102 as the external image data. The control unit 102c of the image forming apparatus 102 applies the image processing to the external image data.

Anyway, the image forming apparatus 102 forms an image on a recording paper by the image forming unit 102e according to the external image data or the internal image data.

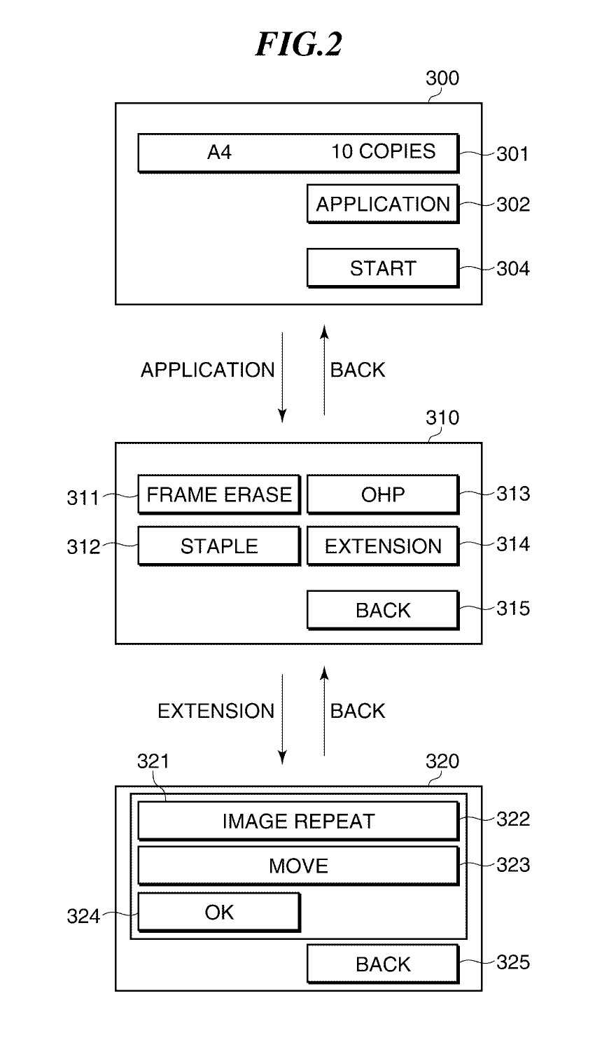

FIG. 2 is a view showing an example of the job setting screen displayed on the operation unit 102f of the image forming apparatus 102 shown in FIG. 1.

As shown in FIG. 2, a basic screen 300 is first displayed on the operation unit 102f as the job setting screen. Before a printing execution, the control unit 102c displays this basic screen 300 on the operation unit 102f. A size and copy number readout 301, an application button 302, and a start button 304 are displayed on the basic screen 300.

The size and copy number readout 301 displays the sheet size that a user sets in a sheet selection screen (not shown) and the number of copies that the user sets with a 10-button keypad (not shown). In the illustrated example, “A4” and “10 copies” are displayed as the sheet size and the copy number, respectively.

The application button 302 is used for displaying an application mode screen 310 (a setting screen for setting a function of the image forming apparatus (it is also called a print processing function)) mentioned later.

When the start button 304 is pressed in the basic screen 300, the control unit 102c starts a print job.

When the application button 302 is pressed in the basic screen 300, the control unit 102c displays the application mode screen 310 on the operation unit 102f. The control unit 102c reads a screen resource from the storage unit 102b, and displays this application mode screen on the operation unit 102f. In this application mode screen 310, the user performs the job setting to the image data inputted from the image input unit 102d. The print processing function selected by the job setting may be called a selected print processing function (it is also called a selected internal image processing function). Then, the print processing function of the image forming apparatus 102 is selectably used by the job setting.

In the application mode screen 310, a frame erasing button 311, a staple button 312, an OHP button 313, an extension button 314, and a back button 315 are displayed. The frame erasing button 311, the staple button 312, and the OHP button 313 are used for setting the functions of the image forming apparatus 102. When detecting a depression of one of these buttons, the control unit 102c reads a corresponding screen resource from the storage unit 102b, and displays it on the operation unit 102f.

When the frame erasing button 311 is pressed, the control unit 102c displays a frame erasing detailed setting screen (not shown) on the operation unit 102f. Then, margin quantity can be designated on the frame erasing detailed setting screen when a predetermined margin is given around an outputted image.

When the staple button 312 is pressed, the control unit 102c displays a staple setting screen (not shown) on the operation unit 102f. This enables to set the positions of stapling and the number of staples.

When the OHP button 313 is pressed, the control unit 102c displays an OHP setting screen (not shown) on the operation unit 102f. This enables the user to select one of settings including a setting that prints an image that is the same as the image printed on the OHP sheet on an insertion sheet, a setting that outputs a blank insertion sheet, etc. when printing an OHP sheet. The control unit 102c stores the set values (internal setting parameters) set on these setting screens into the storage unit 102b.

When the extension button 314 is pressed, the control unit 102c displays an extension mode screen 320 on the operation unit 102f. When the back button 315 is pressed, the control unit 102c returns to the basic screen 300. That is, the control unit 102c displays the basic screen 300 on the operation unit 102f.

The extension mode screen 320 is constituted by a browser screen 321. The browser screen 321 displays the Web page, which the control unit 102c received from the external apparatus 101, on the operation unit 102f. In the extension mode screen 320, the job setting at the time of the image processing by the control unit 101c of the external apparatus 101 is performed with respect to the above-mentioned internal image data.

The image processing function selected by the job setting is called a selected image processing function (it is also called a selected external image processing function). Then, the print processing function of the image forming apparatus 101 is selectably used by the job setting.

As illustrated, the extension mode screen 320 includes a back button 325 and the browser screen 321. An image repeat button 322, a button 323, and an OK button 324 are displayed on the browser screen 321.

The Web page is displayed in the following procedure. First, when the depression of the extension button 314 is detected on the application mode screen 310, the control unit 102c reads the Web browser stored in the storage unit 102b and executes. Then, the control unit 102c requests the Web page for displaying on the browser screen 321 from a Web server (not shown) controlled by the control unit 101c of the external apparatus 101.

The Web server that operates on the external apparatus 101 reads the designated Web page from the storage unit 101b, and sends it to the image forming apparatus 102. When receiving the Web page concerned, the control unit 102c displays it on the operation unit 102f.

When detecting a user's input on the Web page screen (the browser screen 321), the control unit 102c sends input information (set value etc.) to the Web server of the external apparatus 101 using the HTTP. The Web server of the external apparatus 101 sends a different Web page to the image forming apparatus 102 according to the received input information. The Web server stores the input information (the set value, which is also called an external setting parameter) to the storage unit 101b.

For example, the image repeat button 322 and the move button 323 that are illustrated are used for performing job setting in the Web page. When the image repeat button 322 is pressed, the control unit 102c displays a Web page (not shown) of an image repeat setting screen on the operation unit 102f. Then, the user can set the numbers of repeats of images in a principal scanning direction and an auxiliary scanning direction on the image repeat setting screen.

When the move button 323 is pressed, the control unit 102c displays a Web page of a movement setting screen (not shown) on the operation unit 102f. Then, the user can set the location of the image that would be printed on a recording sheet in the movement setting screen. That is, the user can select a printing location of the image among the center, the upper right, the upper left, the lower right, and the lower left of the recording sheet. The storage unit 101b of the external apparatus 101 stores the set values of the user concerned that have been set on these Web pages.

When the OK button 324 is pressed, the control unit 102c sends an OK signal to the external apparatus 101, and the external apparatus 101 accepts the result of the job setting on the Web page. When the back button 325 is pressed, the control unit 102c finishes the Web browser, and displays the application mode screen 310 on the operation unit 102f.

As mentioned above, when performing the job setting to the external apparatus 101, the Web page of the job setting screen is displayed on the operation unit 102f of the image forming apparatus 102 using the screen resource with which the external apparatus 101 is provided. Then, the storage unit 102b of the external apparatus 101 stores the set value inputted via this Web page.

Thus, the extended function that the external apparatus 101 provides can be executed independently of the image forming apparatus 102. It should be noted that the control programs and the Web pages may be upgraded to add a new image processing function as an extended function (an external image processing function) that the external apparatus 101 provides, or to add input setting items to the existing image processing function.

The setting screen to the function of the image forming apparatus 102 (this function is called an internal image processing function) can be shifted to the setting screen to the image processing function of the external apparatus 101 seamlessly. Therefore, the user easily understands that the setting procedure is performed for one print job.

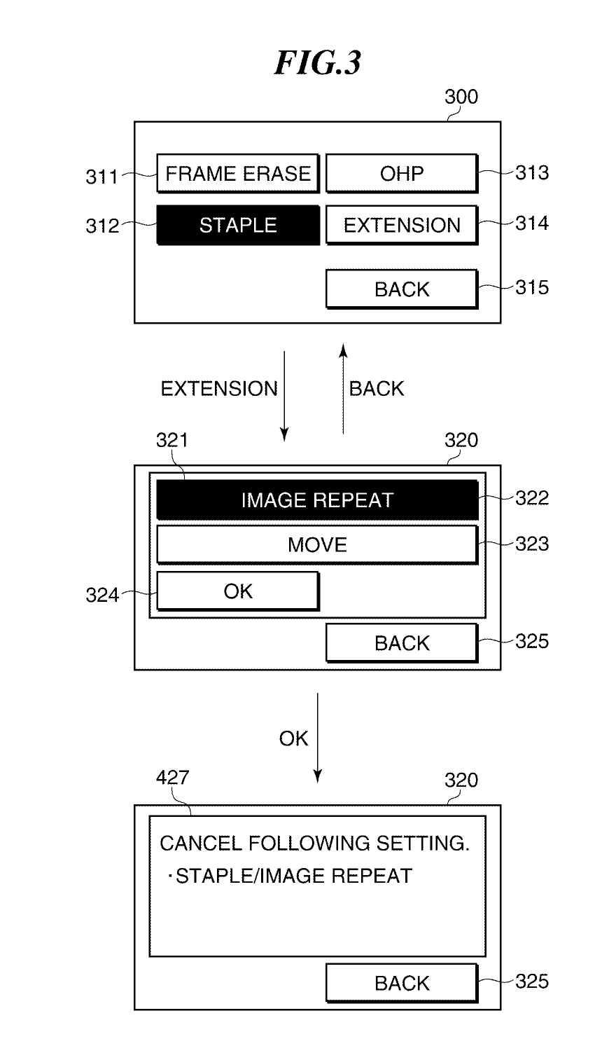

FIG. 3 is a view showing an example of prohibition when a job setting is performed on the job setting screen shown in FIG. 2.

The following description assumes that the setting has been performed based on the following conditions. The staple button 312 in the application mode screen 310 is being pressed, and the image repeat button 322 in the extension mode screen 320 is being pressed. It should be noted that the image forming apparatus 102 performs a staple process and the external apparatus 101 performs an image repeating process when both the staple button 312 and the image repeat button 322 are pressed.

Here, if the combination of the staple process and the image repeating process is improper (prohibition), the control unit 101c of the external apparatus 101 displays an error screen 427 using a Web page when an OK button 424 displayed on the Web page 321 is pressed. A message “CANCEL FOLLOWING SETTING. STAPLE/IMAGE REPEAT” is displayed in this error screen 427, for example. In this way, the image processing functions that cannot be combined simultaneously are displayed to urge the user to change the setting.

It should be noted that the print job cannot be executed until the setting of improper combination is canceled. In other words, when receiving a notice of prohibition (it is called a prohibition notice) from the external apparatus 101, the control unit 102c stops execution of the print job. In order to execute the print job, the Web page 427 generated by the external apparatus 101 should be notified and the start of the print job (depression of the start button 304 shown in FIG. 2) is necessarily checked. This point will be described below.

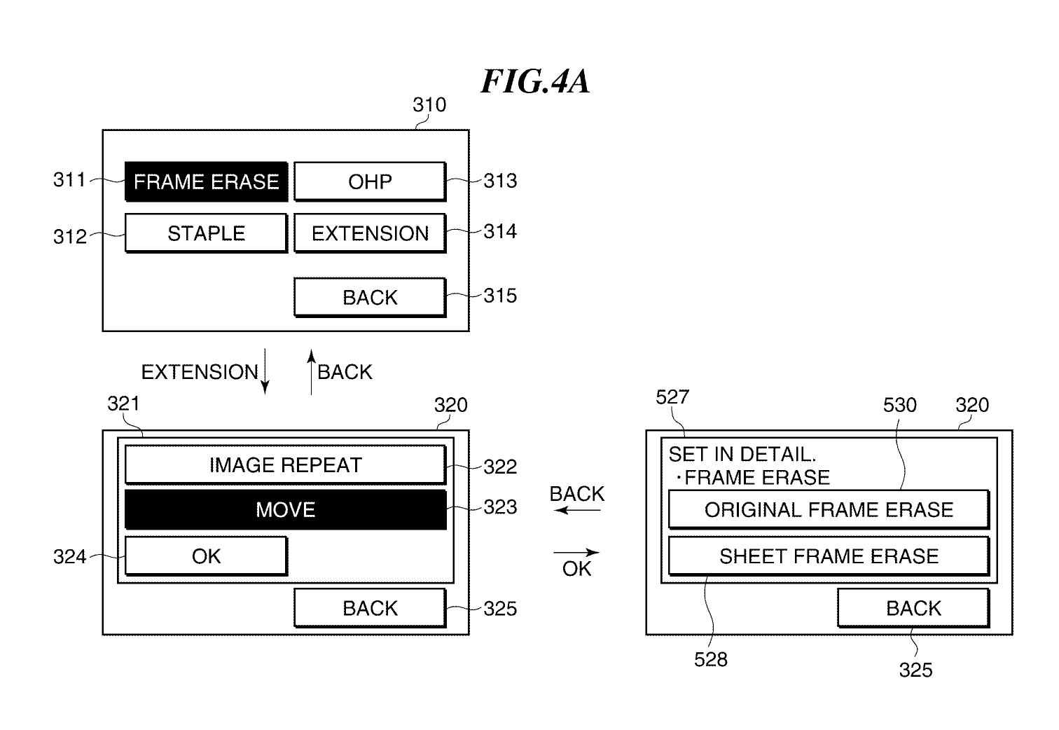

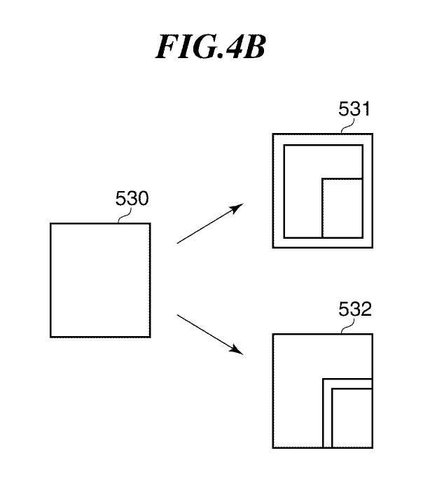

FIG. 4A is a view showing another example of prohibition when a job setting is performed on the job setting screen shown in FIG. 2. FIG. 4B is a view showing an example of a process according to the job set up on the job setting screen shown in FIG. 4A.

The following description assumes that the setting has been performed based on the following conditions. The frame erasing button 311 in the application mode screen 310 is being pressed, and the move button 323 in the extension mode screen 320 is being pressed (see FIG. 4A).

In this case, an outputted image will become undefined when a frame erasing process and a moving process are combined. That is, if the image forming apparatus 102 performs the frame erasing process and then the external apparatus 101 performs the moving process according to the order of the processes, an outputted image 532 will be obtained based on an inputted image 530 (see FIG. 4B).

On the other hand, if the external apparatus 101 performs the moving process and then the image forming apparatus 102 performs the frame erasing process, an outputted image 531 will be obtained based on the inputted image 530 (see FIG. 4B).

When the outputted image becomes different (i.e., become undefined) according to the order of the processes, the user may obtain an unexpected result. Therefore, one solution is to prohibit the combination of such processes as a prohibition.

However, if the external apparatus 101 generates the Web page 527 as shown in FIG. 4A, the above undefined result can be solved. That is, the output result is explicitly shown to the user through the Web page 527 (image). In the example shown in FIG. 4A, a message “SET IN DETAIL. FRAME ERASE” is displayed in the Web page 527, and an original frame erasing button 528 and a sheet frame erasing button 530 are displayed.

Then, for example, when the original frame erasing button 530 is pressed, the outputted image 532 shown in FIG. 4B is displayed as the output result. On the other hand, when the sheet frame erasing button 528 is pressed, the outputted image 531 shown in FIG. 4B is displayed as the output result. It should be noted that an operation including a determination process for displaying the Web page 527 will be mentioned later.

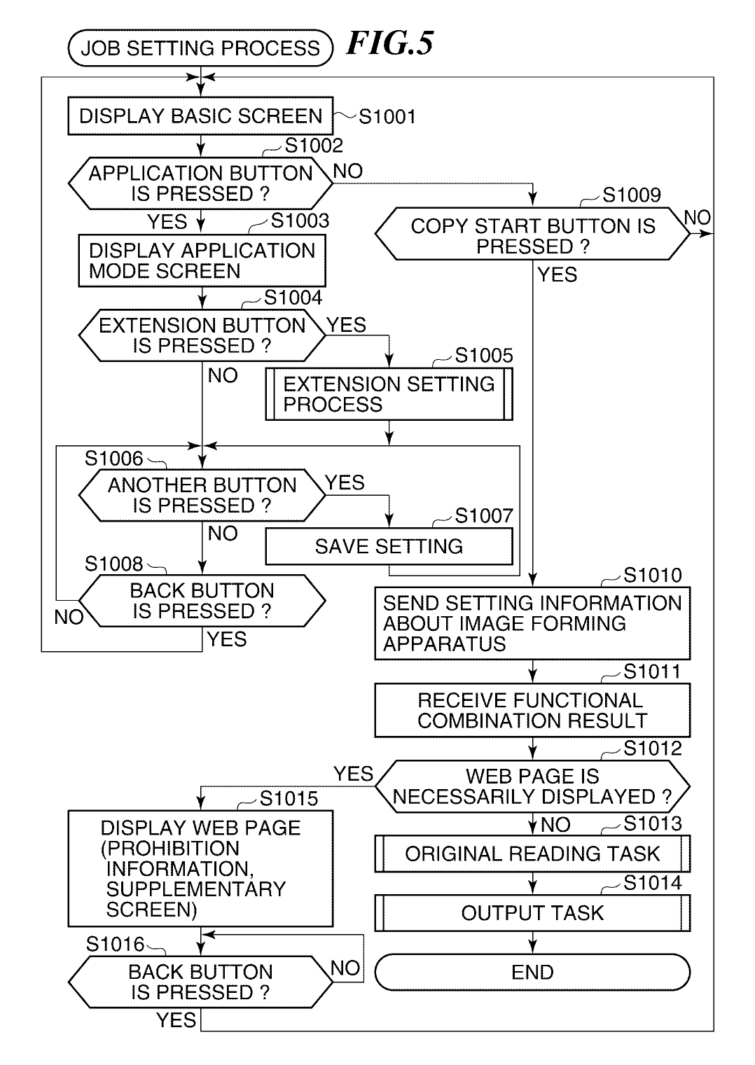

FIG. 5 is a flowchart showing a job setting process in the image forming apparatus 102 shown in FIG. 1.

The job setting process will be described with reference to FIG. 1, FIG. 2, and FIG. 5. When this process starts, the control unit 102c displays the basic screen 300 on the operation unit 102f (step S1001). Next, the control unit 102c determines whether the application button 302 on the basic screen 300 is pressed (step S1002).

When determining that the application button 302 has been pressed (YES in the step S1002), the control unit 102c reads the application mode screen 310 from the storage unit 102b and displays it on the operation unit 102f (step S1003). And the control unit 102 determines whether the extension button 314 is pressed (step S1004).

When determining that the extension button has been pressed (YES in the step S1004), the control unit 102c displays the above-mentioned extension mode screen 320 on the operation unit 102f. In this way, an extension setting process is performed using the above-mentioned Web page (step S1005). Details of the extension setting process will be described below.

When determining that the extension button is not pressed (NO in the step S1004) or when the extension setting process in the step S1005 is completed, the control unit 102c determines whether a button corresponding to a function of the image forming apparatus 102 other than the extension button 314 (it is hereafter called another button) has been pressed (step S1006). When determining another button has been pressed (YES in the step S1006), the control unit 102c saves the setting into the storage unit 102b (step S1007), and returns the process to the step S1006. For example, when the staple button 312 is pressed as another button, the control unit 102c displays the staple setting screen, and saves the setting information inputted through the screen.

On the other hand, when determining that another button is not pressed (NO in the step S1006), the control unit 102c determines whether the back button 315 is pressed (step S1008). When determining that the back button 315 has been pressed (YES in the step S1008), the control unit 102c returns the process to the step S1001. On the other hand, when determining that the back button 315 is not pressed (NO in the step S1008), the control unit 102c returns the process to the step S1006.

In this way, when determining that the application mode button 302 is pressed in the step S1002, the control unit 102c sets the functions of the image forming apparatus 102 and sets the functions of the external apparatus 101 through the Web page.

When determining that the application mode button 302 is not pressed in the step S1002 (NO in the step S1002), the control unit 102c determines whether the start buttons 304 (for example, a copy start button) is pressed (step S1009). When determining that the start button 304 is not pressed (NO in the step S1009), the control unit 102c returns the process to the step S1001.

On the other hand, when determining that the start button 304 has been pressed (YES in the step S1009), the control unit 102c sends the setting information about the image forming apparatus 102 stored in the storage unit 102b to the external apparatus 101(step S1010). The setting information about the image forming apparatus is used for determinations when performing a prohibition process and a supplementary setting together with setting information that is stored in the storage unit 101b of the external apparatus 101, as described below.

That is, the external apparatus 101 determines whether the prohibition process and the supplementary setting will be performed according to the above-mentioned information. Then, the external apparatus 101 sends determination results (functional combination results) of the prohibition process and the supplementary setting to the image forming apparatus 102 as mention later.

In the image forming apparatus 102, when receiving the determination results (confirmation results) in step S1011, the control unit 102c determines whether the determination results require the prohibition process or the supplementary setting (step S1012). That is, the control unit 102c determines whether the determination results require displaying the Web page on the operation unit 102f.

When determining that the Web page is not required displaying (NO in the step S1012), the control unit 102c executes an original reading process (an original reading task) by using the image input unit 102d (step S1013). Then, the control unit 102c stores the image data obtained by reading the original into the storage unit 102b.

Next, the control unit 102c controls the image forming unit 102e to print the image data read from the storage unit 102b (an output task, step S1014), and finishes the printing process. It should be noted that the details of the original reading task and the output task will be mentioned later.

On the other hand, when determining that the Web page is required displaying (YES in the step S1012), the control unit 102c receives the Web page from the external apparatus 101, and displays the Web page on the operation unit 102f (step S1015). The Web page concerned includes the prohibition information and the supplementary information (screens). For example, the Web page 427 shown in FIG. 3 or the Web page 527 shown in FIG. 4 is displayed on the operation unit 102f.

Then, the control unit 102c determines whether the back button 325 in the screen on which the Web page 427 or 527 is displayed has been pressed (step S1016). When determining that the back button 325 has been pressed (YES in the step S1016), the control unit 102c returns the process to the step S1001. On the other hand, when the back button 325 is not pressed (NO in the step S1016), the control unit 102 waits.

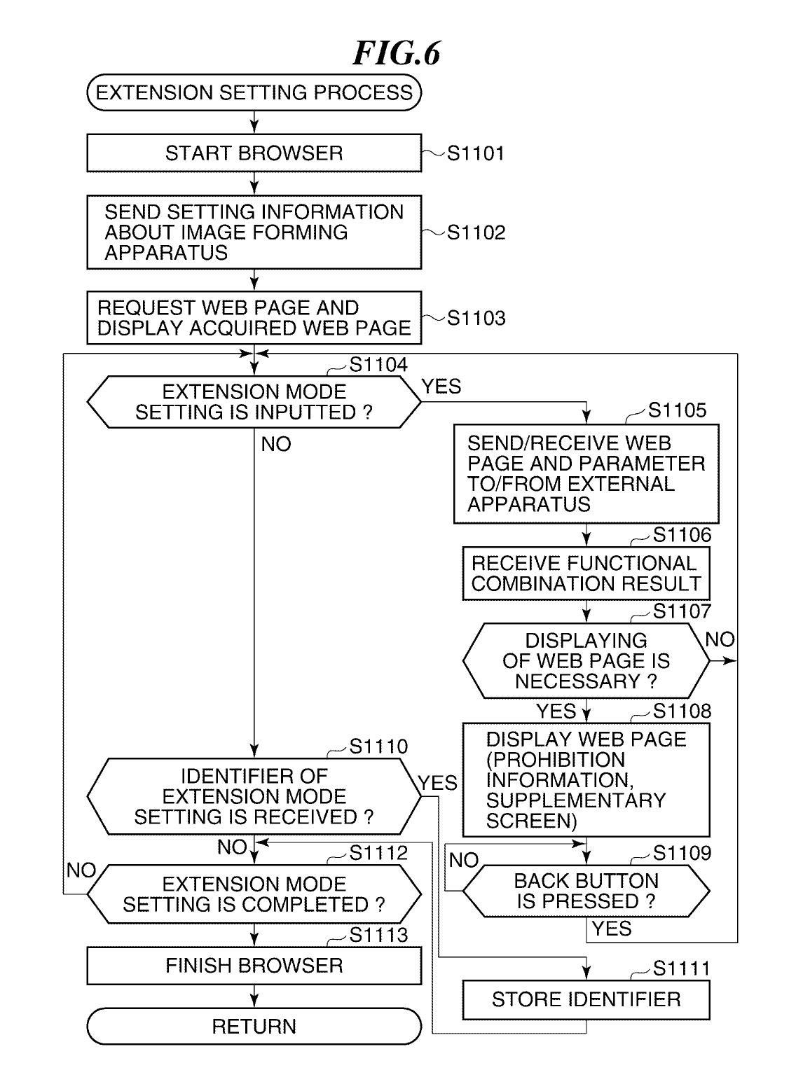

FIG. 6 is a flowchart showing the extension setting process executed in the step S1005 in FIG. 5.

The extension setting process will be described with reference to FIG. 1, FIG. 2, and FIG. 6. When the extension button 314 is pressed in the step S1004 in FIG. 5, the control unit 102c calls the extension setting process in the step S1005. First, the control unit 102c displays the extension mode screen 320 on the operation unit 102f. Next, the control unit 102c starts the Web browser (step S1101). Then, the control unit 102c sends the setting information about the image forming apparatus stored in the storage unit 102b to the external apparatus 101 (step S1102).

Next, the control unit 102c requests a Web page of the top screen for the extension setting from the Web server that operates on the external apparatus 101. Then, the control unit 102c displays the Web page acquired in response to this request on the browser screen 321 (step S1103).

Then, the control unit 102c determines whether the extension mode setting has been inputted to the browser screen 321 (step S1104). Here, it is determined that the extension mode setting is inputted when the image repeat button 322 or the move button 323 indicated in FIG. 2 is pressed, for example.

When the extension mode setting has been inputted (YES in the step S1104), the control unit 102c acquires the Web page corresponding to an applicable button from the external apparatus 101.

In the following description, it is assumed that the image repeat button 322 is pressed as the input of the extension mode setting. When the image repeat button 322 is pressed, the control unit 102c requests the Web page for the image repeat setting screen from the external apparatus 101. Then, the control unit 102c displays the Web page of the image repeat setting screen acquired by the request concerned on the browser screen 321.

When a setup about the image repeat is performed through the image repeat setting screen, the control unit 102c sends a set value (an image repeat set value) to the external apparatus 101. In this way, the control unit 102c sends/receives the Web pages and the parameters (the set values) to/from the external apparatus 101 (step S1105).

Next, the control unit 102c receives the determination results of the prohibition process etc. from the external apparatus 101, for example (step S1106). That is, the control unit 102c acquires the functional combination result.

Next, the control unit 102c determines whether the prohibition process or the supplementary setting is required according to the determination results (step S1107). That is, the control unit 102c determines whether the displaying of the Web page is necessary.

When determining that the displaying of the Web page is necessary (YES in the step S1107), the control unit 102c receives the Web page from the external apparatus 101, and displays the Web page concerned on the operation unit 102f (step S1108). Here, the Web page 427 in FIG. 3 or the Web page 527 in FIG. 4A is displayed, for example.

Next, the control unit 102c determines whether the back button 325 in the screen on which the Web page 427 or the Web page 527 is displayed has been pressed (step S1109). When determining that the back button 325 has been pressed (YES in the step S1109), the control unit 102c returns the process to the step S1104 and continues the process. On the other hand, when the back button 325 is not pressed (NO in the step S1109), the control unit 102 waits.

It should be noted that the control unit 102c returns the process to the step S1104 and continues the process when determining that the displaying of the Web page is unnecessary (NO in the step S1107).

When there is no input of the extension mode setting (NO in the step S1104), the control unit 102c determines whether an identifier of the extension mode setting mentioned later is received from the external apparatus 101 (step S1110).

When receiving the identifier of the extension mode setting (YES in the step S1110), the control unit 102c stores the identifier of the extension mode setting concerned to the storage unit 102b (step S1111). On the other hand, when the identifier of the extension mode setting is not received (NO in the step S1110), the control unit 102c determines whether the back button 325 has been pressed. That is, the control unit 102 determines whether the extension mode setting is completed (step S1004).

When determining that the back button 325 is pressed (YES in the step S1112), the control unit 102c finishes the Web browser (step S1113) and switches from the extension mode screen 320 to the application mode screen 310. On the other hand, when determining that the back button 325 is not pressed (NO in the step S1112), the control unit 102c returns the process to the step S1104 and continues the process.

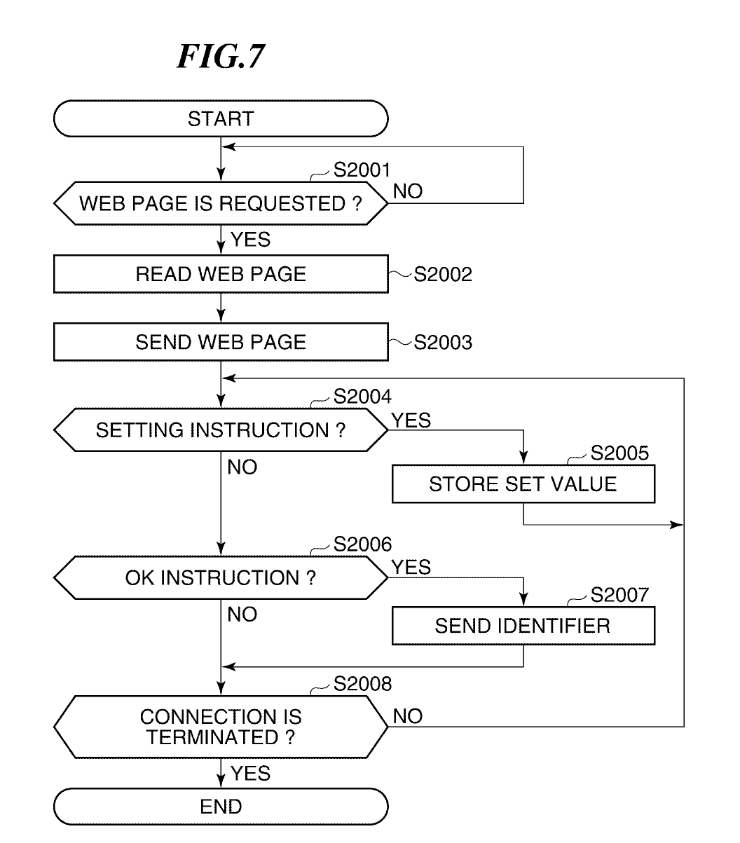

FIG. 7 is a flowchart showing a control process in the external apparatus 101 shown in FIG. 1.

Control of the external apparatus 101 will be described with reference to FIG. 1 and FIG. 7. The control unit 101c of the external apparatus 101 determines whether a Web page request is received from the image forming apparatus 102 (step S2001). When the Web page request is not received (NO in the step S2001), the control unit 101c waits.

On the other hand, when receiving the Web page request (YES in the step S2001), the control unit 101c reads the Web page of the top screen for performing an extension setting from the storage unit 101b (step S2002). Then, the control unit 101c sends the Web page concerned to the image forming apparatus 102 (step S2003).

Next, the control unit 101c determines whether an event to the Web page is received from the image forming apparatus 102 (a setting instruction: step S2004). In the example shown in FIG. 2, the depression of the image repeat button 322 or the move button 323 corresponds to the event.

Here, it is assumed that the image repeat button 322 has been pressed. When the event of the depression of the image repeat button 322 is received (YES in the step S2004), the control unit 101c sends a Web page of the image repeat screen to the image forming apparatus 102. Then, when receiving an image repeat set value that is set in the image forming apparatus 102, the control unit 101c stores the image repeat set value concerned into the storage unit 101b as a job set value (step S2005), and returns the process to the step S2004.

When not receiving the event of the depression of the image repeat button 322 (NO in the step S2004), the control unit 101c determines whether an event of the depression of the OK button 324 is received from the image forming apparatus (an OK instruction: step S2006).

When receiving the event of the depression of the OK button 324 (YES in the step S2006), the control unit 101c allocates an identifier (a job setting identifier) that identifies the job set value stored in the storage unit 101b in the step S2005. Then, the control unit 101c stores the identifier concerned to the storage unit 101b and sends it to the image forming apparatus 102 (step S2007).

When the event of the depression of the OK button 324 is not received (NO in the step S2006), or when the identifier is sent in the step S2007, the control unit 101c determines whether the connection has been terminated (step S2008).

When the connection has not been terminated (NO in the step S2008), the control unit 101c returns the process to the step S2004 and continues the process. On the other hand, when the connection has been terminated (YES in the step S2008), the control unit 101c finishes the process.

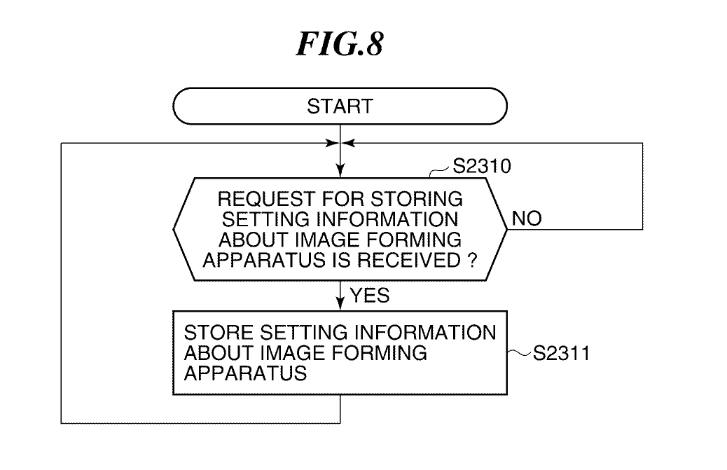

FIG. 8 is a flowchart showing a process for storing information about the image forming apparatus 102 into the external apparatus 101 shown in FIG. 1.

A job storing process will be described with reference to FIG. 1 and FIG. 8. The control unit 101c executes the process shown in FIG. 8 according to a program stored in the storage unit 101b when the external apparatus 101 is started.

First, the control unit 101c determines whether a request for storing the setting information about the image forming apparatus has been received from the image forming apparatus 102 (step S2310). When receiving the request concerned (YES in the step S2310), the control unit 101c stores the setting information about the image forming apparatus into the storage unit 101b as received data, and returns the process to the step S2310. On the other hand, when the above-mentioned request has not been received (NO in the step S2310), the control unit 101c waits.

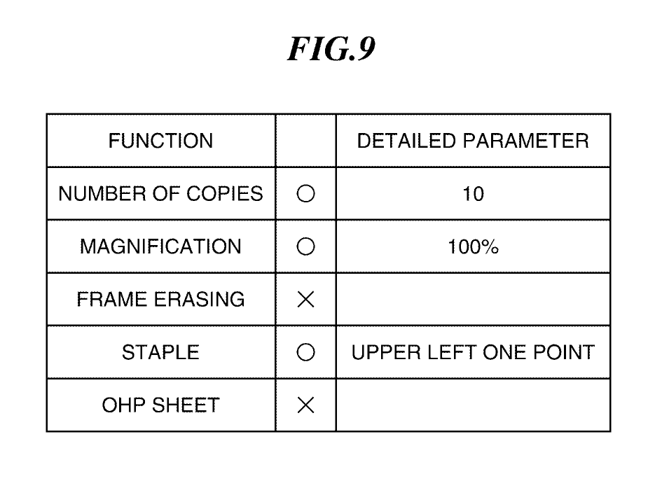

FIG. 9 is a view showing an example of received data described in FIG. 8 in detail.

In FIG. 9, the setting information about the image forming apparatus includes a plurality of setting items (functions). Here, there are the number of copies, a magnification, frame erasing, a staple, and an OHP sheet as the setting items. It is shown for each of these setting items whether the setting concerned is effective. In the illustrated example, a “round mark” is attached when being effective, and a “cross mark” is attached when being ineffective.

A detailed parameter is specified for each of the setting items. This detailed parameter is the above-mentioned setting information about the image forming apparatus. Here, “10” is set as the number of copies and “100%” is set as the magnification. In addition, “upper left (one point)” is set as the staple.

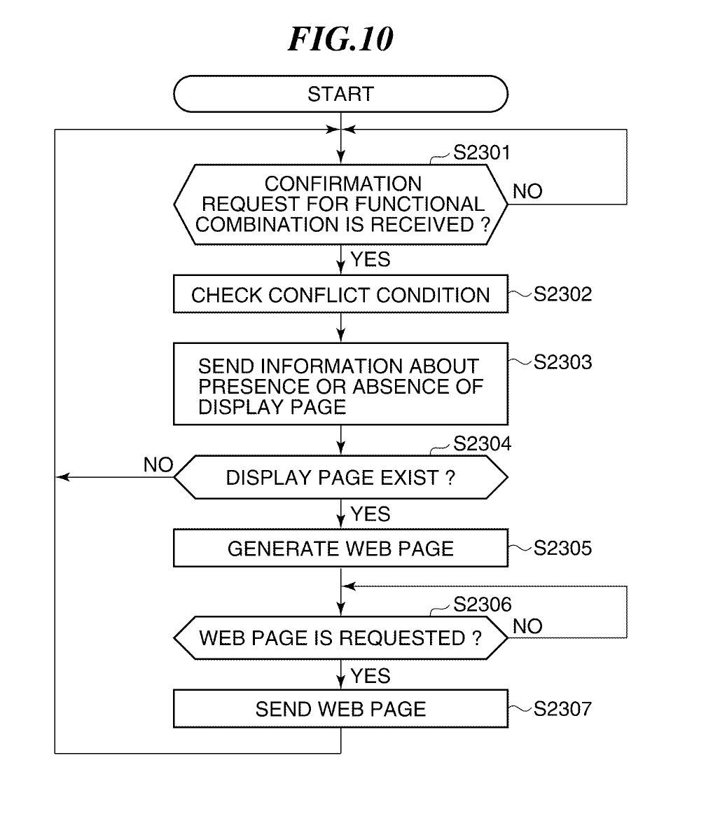

FIG. 10 is a flowchart showing a prohibition process and a supplementary setting in the external apparatus 101 shown in FIG. 1.

The prohibition process and the supplementary setting will be described with reference to FIG. 1 and FIG. 10. The control unit 101c immediately executes the process shown in FIG. 10 according to a processing program stored in the storage unit 101b when the external apparatus 101 is started.

The control unit 101c determines whether a confirmation request for the functional combination has been received from the image forming apparatus 102 (step S2301). When the confirmation request has not been received (NO in the step S2301), the control unit 101c waits.

On the other hand, when the above-mentioned confirmation request is received (YES in the step S2301), the control unit 101c reads the received data (the setting information about the image forming apparatus) described in FIG. 8 and the setting information (the setting information about the external apparatus) that the external apparatus 101 has from the storage unit 101b. Then, the control unit 101c compares the setting information about the image forming apparatus with the setting information about the external apparatus, and checks whether a conflict occurs according to conditions (conflict determination conditions) set beforehand (step S2302).

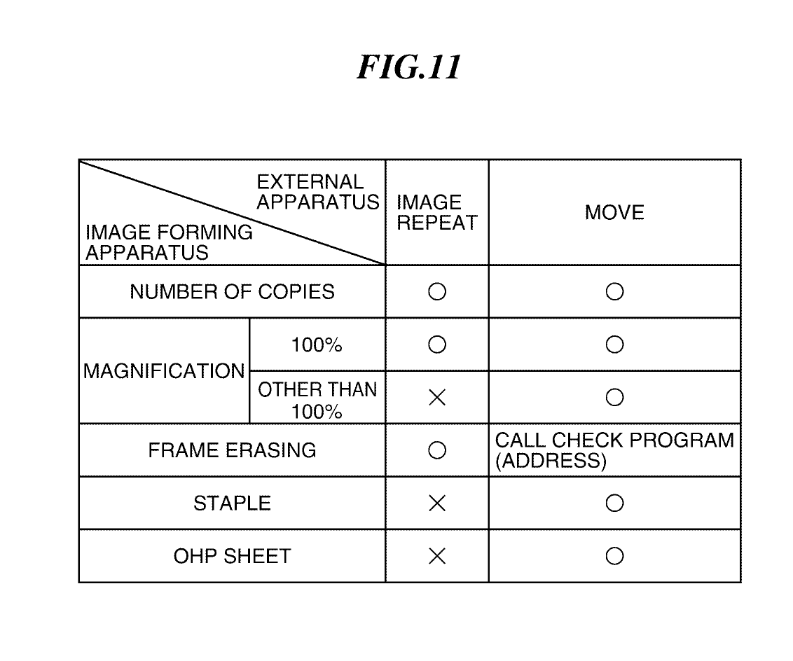

FIG. 11 is a view showing an example of the conflict determination condition stored in the storage unit 101b of the external apparatus 101 shown in FIG. 1.

In FIG. 11, the “number of copies”, the “magnification”, the “frame erasing”, the “staple”, and the “OHP sheet” are specified as the setting items for the image forming apparatus 102. Then, “100%” and “except 100%” are specified for the “magnification”. On the other hand, the “image repeat” and the “movement” are specified as setting items for the external apparatus 101. Then, the “round mark” is attached to the function that can be combined, and the “cross mark” is attached to the function that cannot be combined.

In the illustrated example, the image repeat can be combined with the number of copies, the magnification of 100%, and the frame erasing. In the illustrated example, the propriety of combination differs according to the magnification (100% or not) even if the function belongs to the same setting category of the magnification.

In the illustrated example, when the combination of the “movement” and the “frame erasing” are set, it is specified to call a check program (an address). That is, when performing combination, a start of another program may be designated. The Web page 527 set in FIG. 4A is a sample of the screen that displays this point.

A sequel of the prohibition process and the supplementary setting will be described with reference to FIG. 1 and FIG. 10. As mentioned above, the control unit 101c compares the setting information about the image forming apparatus with the setting information about the external apparatus according to the conflict determination conditions, and checks and determines whether the functional combination is available. Then, the control unit 101c sends a determination result (it is also called a confirmation result) that shows whether it is necessary to open a Web page (it is also called a display page) to the image forming apparatus 102. That is, the control unit 101c sends the determination result that shows presence or absence of a Web page to the image forming apparatus 102 as a reply (step S2303).

Next, the control unit 101c determines whether it is necessary to open the Web page corresponding to the above-mentioned confirmation result (step S2304). Then, when determining that it is necessary to open the Web page (YES in the step S2304), the control unit 101c generates the Web page that should be displayed on the image forming apparatus 102 (step S2305). This Web page is the Web page 527 described in FIG. 3 or the Web page 427 described in FIG. 4A, for example.

It should be noted that the control unit 101c returns the process to the step S2301 and continues the process when determining that it is unnecessary to open the Web page (NO in the step S2304).

Next, the control unit 101c determines whether the Web page request is received from the image forming apparatus 102 (step S2306). When receiving the Web page request (YES in the step S2306), the control unit 101c sends the Web page (contents) generated in the step S2305 to the image forming apparatus 102 (step S2307). When the Web page request is not received (NO in the step S2306), the control unit 101c waits.

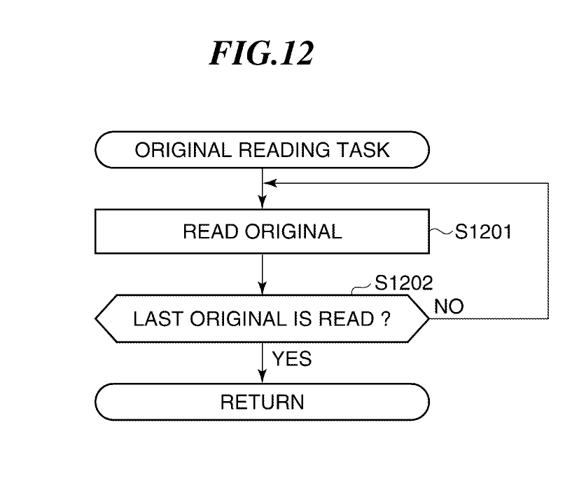

FIG. 12 is a flowchart showing the original reading task executed in the step S1013 in FIG. 5 in detail.

The original reading task will be described with reference to FIG. 1 and FIG. 12. In step S1012 of FIG. 5, when it is determined that the prohibition process or the supplementary setting is unnecessary, the original reading task starts. That is, the original reading task is called when the determination result by the external apparatus 101 is a non-prohibition notice.

When the original reading task starts, the control unit 102c controls the image input unit 102d to start reading an original document. Then, the control unit 102c stores image data obtained by reading the original into the storage unit 102b (step S1201).

Next, the control unit 102c determines whether the last original has been read, i.e., whether all the originals have been read (step S1202). When the last original has not read (NO in the step S1202), the control unit 102c returns the process to the step S1201. On the other hand, when all the originals have been read (YES in the step S1202), the control unit 102c finishes the original reading task, and returns to the process in FIG. 5.

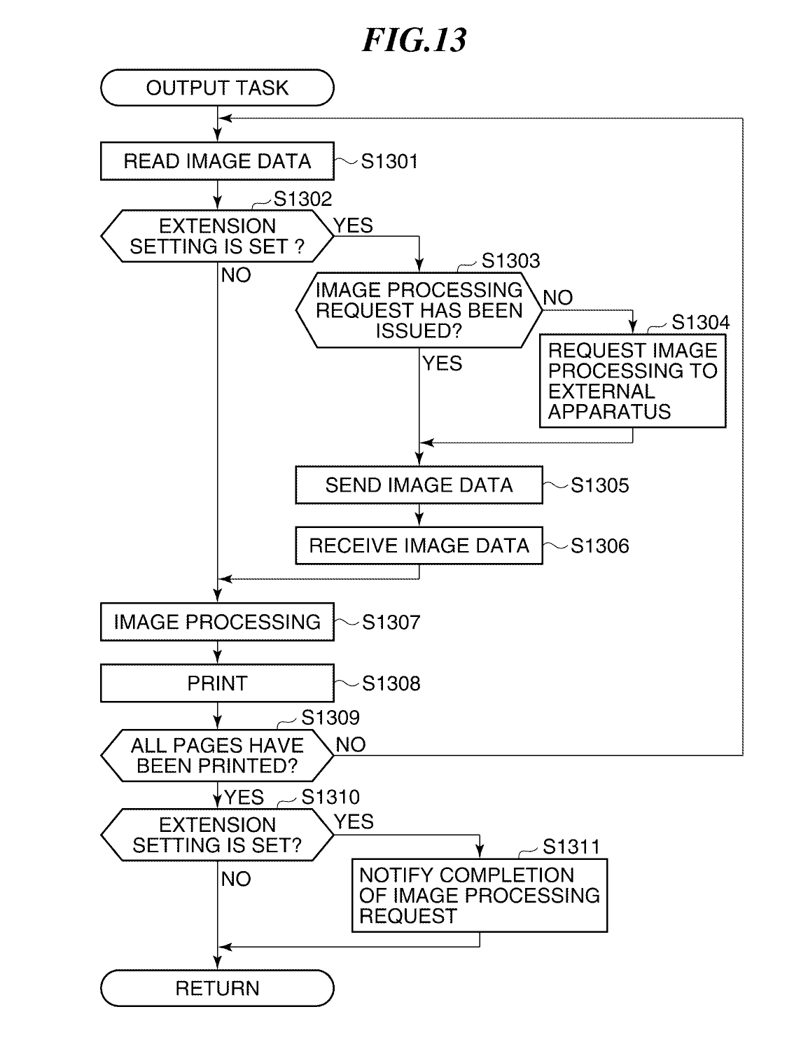

Next, control for outputting an image in the image forming apparatus 102 will be described. FIG. 13 is a flowchart showing an output task executed in the step S1014 in FIG. 5 in detail.

The output task will be described with reference to FIG. 1 and FIG. 13. When the output task starts, the control unit 102c will read image data from the storage unit 102b (step S1301). Next, the control unit 102c determines whether the above-mentioned identifier is stored in the storage unit 102b. That is, the control unit 102c determines whether the extension setting has been set (step S1302). When the extension setting has been set (YES in the step S1302), the control unit 102c determines whether an image processing request is issued to the external apparatus 101 (step S1303).

When the image processing request is not issued (NO in the step S1303), the control unit 102c sends the identifier read from the storage unit 102b to the external apparatus 101, and requests the image processing (step S1304). When the image processing request has been issued (YES in the step S1303), or when the image processing is requested in the step S1304, the control unit 102c reads image data from the storage unit 102b, and sends it to the external apparatus 101 as the internal image data (step S1305).

In this way, when the determination result by the external apparatus 101 in the step S1012 described in FIG. 5 is the non-prohibition notice, the control unit 102c sends the internal image data to the external apparatus 101 for the image processing.

The control unit 102c receives the image data to which the image processing has been applied in the control unit 101c from the external apparatus 101 as the external image data (step S1306). Then, the control unit 102c applies the image processing based on the set values described in the step S1007 in FIG. 5 to the external image data (step S1307). Here, the image processing concerning the image movement is performed.

When the extension setting is not set (NO in the step S1302), the control unit 102c proceeds with the process to step S1307, and executes the image processing without using the external apparatus 101.

Next, the control unit 102c controls the image forming unit 102e so as to execute printing according to the processed image data (step S1308). Then, the control unit 102c determines whether all the pages concerning the processed image data have been printed (step S1309).

When not all the pages have been printed (NO in the step S1309), the control unit 102c returns the process to the step S1301 and continues the process.

On the other hand, when all the pages have been printed (YES in step S1309), the control unit 102c again determines whether the identifier is stored in the storage unit 102b. That is, the control unit 102c determines whether the extension setting has been set (step S1310).

When the extension setting has been set (YES in the step S1310), the control unit 102c notifies the external apparatus 101 of a completion of the image processing request (step S1311), and finishes the output task. On the other hand, when the extension setting has not been set (NO in the step S1310), the control unit 102c finishes the output task without notifying.

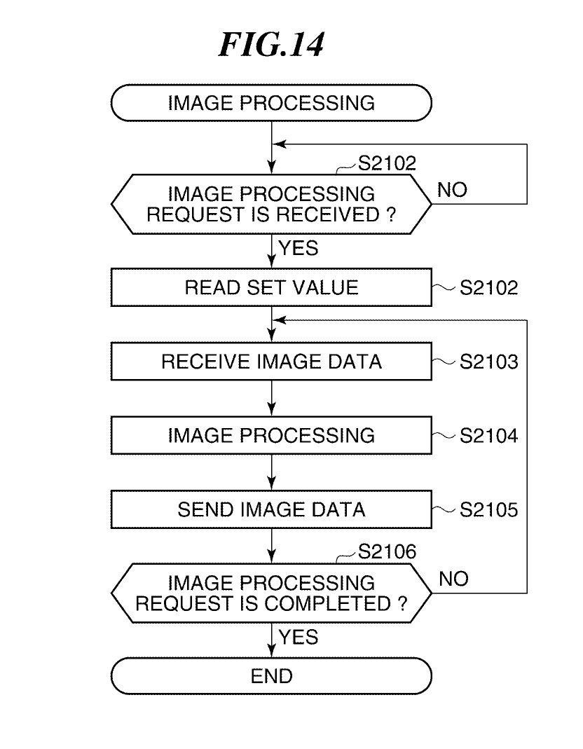

Next, the image processing in the external apparatus 101 will be described. FIG. 14 is a flowchart showing the image processing in the external apparatus 101 shown in FIG. 1.

The image processing will be described with reference to FIG. 1 and FIG. 14. When the image processing starts, the control unit 101c determines whether the image processing request is received from the image forming apparatus 102 (step S2101). When the image processing request has not been received (NO in the step S2101), the control unit 101c waits.

On the other hand, when the image processing request has been received (YES in the step S2101), the control unit 101c reads the set value in the Web page corresponding to the identifier included in the image processing request from the storage unit 101b (step S2102). Then, the control unit 101c receives the internal image data from the image forming apparatus 102 (step S2103). Then, the control unit 101c applies the image processing to the internal image data according to the set value in the Web page (step S2104).

Next, the control unit 101c sends the image data to which the image processing has been applied to the image forming apparatus 102 as the external image data (step S2105). Then, the control unit 101c determines whether a completion of the image processing request is received from the image forming apparatus 102 (step S2306).

When the completion of the image processing request is not received (NO in the step S2106), the control unit 101c returns the process to the step S2103 and continues the process. On the other hand, when the completion of the image processing request has been received (YES in the step S2106), the control unit 101c finishes the image processing.

Next, a printing system according to a second embodiment of the present invention will be described. It should be noted that a configuration of the printing system of the second embodiment is identical to that of the printing system described in FIG. 1.

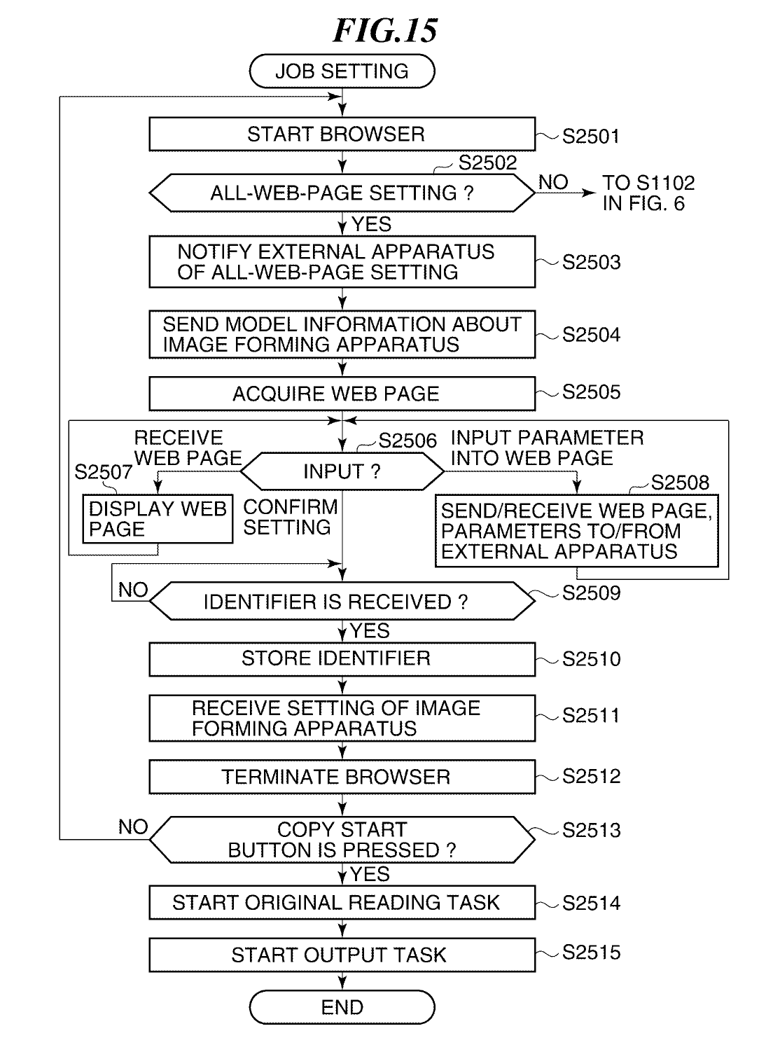

FIG. 15 is a flowchart showing job setting in the image forming apparatus 102 shown in FIG. 1 in the printing system according to the second embodiment of the present invention.

The job setting will be described with reference to FIG. 1 and FIG. 15. When the job setting starts, the control unit 102c starts the Web browser (step S2501). Next, the control unit 102c investigates about whether a notice for performing all the settings through Web pages (it is called an all-Web-page setting) to the external apparatus 102 is issued (step S2502). The all-Web-page setting is performed on an initial-setting registration screen (not shown) displayed on the image forming apparatus 102, for example. Then, when the all-Web-page setting is performed, the control unit 102c stores an all-Web-page setting flag, which shows the all-Web-page setting concerned, into the storage unit 102b.

When the storage unit 102b stores the all-Web-page setting flag (YES in the step S2502), the control unit 102c notifies the external apparatus 101 of the all-Web-page setting (step S2503). That is, the control unit 102c sends a mode selection notice showing the all-Web-page setting to the external apparatus 101. In response to the mode selection notice concerned, the control unit 101c operates in an all-Web-page setting mode, in which all the settings are performed through the Web page.

On the other hand, when the storage unit 102b does not store the all-Web-page setting flag (NO in the step S2502), the control unit 102c proceeds with the process to the step S1102 in FIG. 6.

Next, the control unit 102c sends model information showing a model of the image forming apparatus concerned to the external apparatus 101 (step S2504). The storage unit 101b of the external apparatus 101 stores the functional information that shows functions for each model of the image forming apparatus, for example. In this way, the external apparatus 101 can find what kind of Web page is needed to the image forming apparatus concerned. It should be noted that the image forming apparatus may notify the external apparatus 101 of all the functions that the image forming apparatus has.

Next, the control unit 102c acquires the top page of the Web page from the external apparatus 101 (step S2505). Then, the control unit 102c investigates what kind of input event has occurred (step S2506). Here, since the Web page has been acquired from the external apparatus 101, the control unit 102c determines that there has been the acquisition of the Web page as the input event. That is, when determining that the Web page has been received in the step S2506, the control unit 102c displays the Web page concerned on the screen of the operation unit 102f (step S2507). Then, the control unit 102c returns the process to the step S2506.

When a user inputs a set value on the Web page displayed on the operation unit 102f, the control unit 102c sends the set value concerned (setting parameters) to the external apparatus 101. Then, as mentioned above, the external apparatus 101 sends the prohibition information and another Web page to the image forming apparatus 102. That is, when the user inputs the set value on the Web page displayed on the operation unit 102f, the control unit 102c sends/receives the Web page, the set value, etc., to/from the external apparatus 101 (step S2508). Then, the control unit 102c returns the process to the step S2506.

When receiving the other Web page from the external apparatus 101 in the step S2508, the control unit 102c proceeds with the process to the step S2507, and displays the other Web page on the operation unit 102f. In this way, the various data that includes the Web page is transferred between the image forming apparatus 102 and the external apparatus 101, and the user performs various kinds of settings on the Web page.

When the user confirms the setting on the Web page (confirm setting in the step S2506), the control unit 102c sends a notice of the setting confirmation concerned to the external apparatus 101. In response to the notice of the setting confirmation, the control unit 101c sends the identifier associated with the set value to the image forming apparatus 102.

The control unit 102c determines whether the identifier is received (step S2509). When the identifier is not received (NO in the step S2509), the control unit 102c waits until receiving the identifier.

When receiving the identifier (YES in the step S2509), the control unit 102c stores the identifier concerned to the storage unit 102b (step S2510). Then, the control unit 102c receives the setting information that shows what kind of image processing is applied by the image forming apparatus as a result of the input operation on the Web page (step S2511). This setting information is stored into the storage unit 102b as the setting information about the external apparatus. Next, the control unit 102c terminates the browser (step S2512).

Next, the control unit 102c determines whether the copy start button has been pressed (step S2513), for example. When determining that the copy start button has not been pressed (NO in the step S2513), the control unit 102c returns the process to the step S2501.

On the other hand, when determining that the copy start button has been pressed (YES in the step S2513), the control unit 102c starts reading an original (the original reading task) by using the image input unit 102d (step S2514). Then, the control unit 102c stores the image data obtained by reading the original into the storage unit 102b.

Next, the control unit 102c controls the image forming unit 102e to print the image data read from the storage unit 102b (the output task, step S2515), and finishes the printing process.

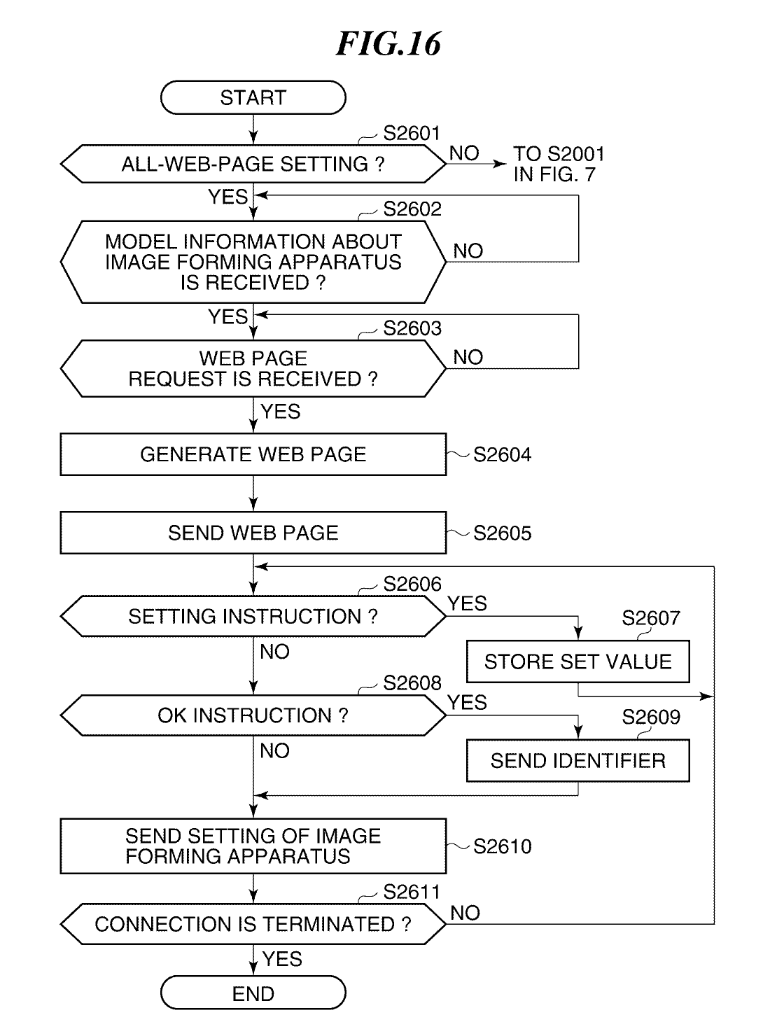

FIG. 16 is a flowchart showing a process in the external apparatus 101 shown in FIG. 1 in the printing system according to the second embodiment of the present invention.

A process of the external apparatus will be described with reference to FIG. 1 and FIG. 16. First, the control unit 101c determines whether the notice of all-Web-page setting is received from the image forming apparatus 102 (step S2601). When the notice of all-Web-page setting is not received (NO in the step S2601), the control unit 101c proceeds with the process to the step S2001 in FIG. 7.

On the other hand, when the notice of all-Web-page setting is received (YES in the step S2601), the control unit 101c determines whether the model information about the image forming apparatus 102 has been received (step S2602). When the model information has not been received (NO in the step S2602), the control unit 101c waits until receiving the model information.

When receiving the model information (YES in the step S2602), the control unit 101c determines whether the Web page request has been received from the image forming apparatus 102 (step S2603). When the Web page request has not been received (NO in the step S2603), the control unit 101c waits until receiving the Web page request.

When receiving the Web page request (YES in the step S2603), in order to set up functions including all the functions of the image forming apparatus through the Web page, the control unit 101c forms the top page of the Web page with reference to the model information (step S2604). Then, the control unit 101c sends the Web page concerned to the image forming apparatus 102 (step S2605).

The input operation through the Web page on the image forming apparatus 102 enables the job setting in the image forming apparatus 102 and the external apparatus 101, as mentioned above. Here, the prohibition process is performed for a plurality of setting functions, as mentioned above.

Next, the control unit 101c determines whether an event to the Web page has been received, i.e., whether a setting instruction has been received, from the image forming apparatus 102 (step S2606). When receiving the setting instruction (YES in the step S2606), the control unit 101c stores the set value designated by the setting instruction concerned to the storage unit 101b (step S2607). And the control unit 101c returns the process to the step S2606.

When the setting instruction is not received (NO in the step S2606), the control unit 101c determines whether an OK instruction has been received, i.e., whether the OK button has been pressed (step S2608).

When receiving the OK instruction (YES in the step S2608), the control unit 101c allocates an identifier (a job setting identifier) for identifying the set value stored in the storage unit 101b. Then, the control unit 101c stores the identifier concerned to the storage unit 101b and sends the identifier to the image forming apparatus 102 (step S2609).

Next, the control unit 101c sends setting information that shows the set values used for setting that the image processing apparatus 102 should perform to the image processing apparatus 102 (step S2610). Then, the control unit 101c determines whether the connection is terminated (step S2611). It should be noted that when there is not the OK instruction of the setting (NO in the step S2608), the control unit 101c proceeds with the process to the step S2610 to determine whether the connection is terminated.

When the connection has not been terminated (NO in the step S2611), the control unit 101c returns the process to the step S2606 and continues the process. On the other hand, when the connection has been terminated (YES in the step S2611), the control unit 101c finishes the process.

Thus, in the second embodiment described in FIG. 15 and FIG. 16, all the settings including the settings about the processes executed by the image forming apparatus 102 are performed through the Web page provided by the external apparatus 101. Thus, since all the settings are performed by the external apparatus 101 once, the conflict of the settings can be smoothly and smartly solved. Accordingly, it is desirable that a user can freely select any settings.

As is evident from the above-mentioned description, the control unit 102c functions as a first setting means, a second setting means, a first sending means, a stopping means, a second sending means, and a third sending means. The control unit 101c functions as a reception means, a judging means, a sending means, and a setting displaying means.

As mentioned above, according to the above embodiments, the prohibition process can be specified among the functions that are provided by both of the image forming apparatus 102 and the external apparatus 101 even if any extended functions are provided by the external apparatus 101 regardless of the functions and the programs of the image forming apparatus 102. This reduces failures in printing, which does not only reduce the cost but also ensure the printing process.

Thus, in the above-mentioned embodiments, the operability for a user when setting an image processing function via the UI screen is improved.

Although the embodiments of the invention have been described, the present invention is not limited to the above-mentioned embodiments, the present invention includes various modifications as long as the concept of the invention is not deviated.

For example, a computer with which the image forming apparatus is provided may execute an image forming method that is defined by the functions of the above-mentioned embodiments. Moreover, the computer with which the image forming apparatus is provided may execute an image forming program that is defined by the functions of the above-mentioned embodiments. In these cases, each of the image formation method and the image formation program has a first setting step, a second setting step, a first sending step, and a second sending step.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### Reference Signs List

101 External Apparatus
102 Image forming device
104 Network
101a and 102a Network communication unit
101b and 102b Storage unit
101c and 102c Control unit
102d Image input unit
102e Image forming unit
102f Operation unit

1. An image forming apparatus having print processing functions that is connected to an information processing apparatus that has image processing functions via a network, comprising:
a first setting means that sets a setting parameter, when at least one of the print processing functions is selected, concerning the selected print processing function as an internal setting parameter;
a second setting means that sets a setting parameter, when at least one of the image processing functions is selected, concerning the selected image processing function as an external setting parameter;
a first sending means that sends the internal setting parameter and the external setting parameter to the information processing apparatus; and
a stopping means that stops the printing process that uses the selected print processing function and the selected image processing function, when receiving a prohibition notice, which shows that the selected print processing function and the selected image processing function cannot be used in combination, as a determination result determined by the information processing apparatus according to the internal setting parameter, the external setting parameter, and a predetermined conflict determination condition.

2. The image forming apparatus according to claim 1, wherein said stopping means displays a message showing the selected print processing function and the selected image processing function cannot be used in combination on a display device when receiving the prohibition notice.

3. The image processing apparatus according to claim 1, wherein said stopping means displays an output result according to an image generated by the combination of the selected print processing function and the selected image processing function on a display device when the image is sent from the information processing apparatus together with the prohibition notice.

4. The image forming apparatus according to claim 1 further comprising a second sending means that sends the image data to the information processing apparatus when the determination result is a non-prohibition notice, which shows that the selected print processing function and the selected image processing function can be used in combination.

5. The image forming apparatus according to claim 1, wherein said first setting means displays a first setting screen for setting the print processing functions, and said second setting means displays a second setting screen for setting the image processing functions.

6. The image forming apparatus according to claim 5, wherein the network is the Internet, and said second setting means receives a Web page from the information processing apparatus and displays the Web page as the second setting screen.

7. The image forming apparatus according to claim 1, further comprising a third sending means that sends a mode selection notice, which shows which mode is selected between a first print setting mode for setting when printing using the print processing function and the image processing function and a second print setting mode for setting when printing using only the image processing function, to the information processing apparatus.

8. An information processing apparatus having image processing functions comprising:
a connecting means that connects to an image forming apparatus that forms an image selectively using print processing functions;
a reception means that receives an internal setting parameter concerning the print processing function and an external setting parameter concerning the image processing function from the image forming apparatus;
a determination means that determines whether the print processing function and the image processing function can be used in combination according to the internal setting parameter, the external setting parameter, and a predetermined conflict determination condition; and
a sending means that sends a determination result by said determination means to the image forming apparatus.

9. The information processing apparatus according to claim 8, wherein said reception means receives the internal setting parameter and the external setting parameter when receiving a notice to select a first print setting mode for setting when printing using the print processing function and the image processing function, and
further comprising a setting-displaying means that displays a setting screen for setting the external setting parameter on the image forming apparatus with reference to the print processing functions of the image forming apparatus when receiving a notice to select a second print setting mode for setting when printing using only the image processing function from the image forming apparatus.

10. A printing system comprising the image forming apparatus according to claim 1, and an information processing apparatus having image processing functions comprising:
a connecting means that connects to the image forming apparatus that forms an image selectively using print processing functions;
a reception means that receives an internal setting parameter concerning the print processing function and an external setting parameter concerning the image processing function from the image forming apparatus;
a determination means that determines whether the print processing function and the image processing function can be used in combination according to the internal setting parameter, the external setting parameter, and a predetermined conflict determination condition; and
a sending means that sends a determination result by said determination means to the image forming apparatus.

11. An image forming method for an image forming apparatus having print processing functions that is connected to an information processing apparatus that has image processing functions via a network, the method comprising:
a first setting step of setting a setting parameter, when at least one of the print processing functions is selected, concerning the selected print processing function as an internal setting parameter;
a second setting step of setting a setting parameter, when at least one of the image processing functions is selected, concerning the selected image processing function as an external setting parameter;
a sending step of sending the internal setting parameter and the external setting parameter to the information processing apparatus; and
a stopping step of stopping the printing process that uses the selected print processing function and the selected image processing function, when receiving a prohibition notice, which shows the selected print processing function and the selected image processing function cannot be used in combination, as a determination result determined by the information processing apparatus according to the internal setting parameter, the external parameter, and a predetermined conflict determination condition.

12. An image forming program causing a computer to execute an image forming method for an image forming apparatus having print processing functions that is connected to an information processing apparatus that has image processing functions via a network, the method comprising:
a first setting step of setting a setting parameter, when at least one of the print processing functions is selected, concerning the selected print processing function as an internal setting parameter;
a second setting step of setting a setting parameter, when at least one of the image processing functions is selected, concerning the selected image processing function as an external setting parameter;
a sending step of sending the internal setting parameter and the external setting parameter to the information processing apparatus; and
a stopping step of stopping the printing process that uses the selected print processing function and the selected image processing function, when receiving a prohibition notice, which shows the selected print processing function and the selected image processing function cannot be used in combination, as a determination result determined by the information processing apparatus according to the internal setting parameter, the external parameter, and a predetermined conflict determination condition.

13. A non-transitory computer-readable storage medium storing the image forming program according to claim 12.

14. An image forming apparatus that has image processing functions, forms an image using the image forming functions, and is connectable to an information processing apparatus having image processing functions, comprising:
a first selection unit that selects at least one of the image processing functions that the image forming apparatus has;
a second selection unit that selects at least one of the image processing functions that the information processing apparatus has;
a sending unit that sends information showing the image processing function selected by said first selection unit and the image processing function selected by said second selection unit to the information processing apparatus;
a reception unit that receives a determination result, which is determined by the information processing apparatus according to the information sent by said sending unit and a predetermined conflict determination condition, from the information processing apparatus; and
a display unit that displays a message according to the determination result received by said reception unit.

15. An image forming method for an image forming apparatus that has image processing functions, forms an image using the image forming functions, and is connectable to an information processing apparatus having image processing functions, the method comprising:
a first selection step of selecting at least one of the image processing functions that the image forming apparatus has;
a second selection step of selecting at least one of the image processing functions that the information processing apparatus has;
a sending step of sending information showing the image processing function selected in said first selection step and the image processing function selected in said second selection step to the information processing apparatus;
a reception step of receiving a determination result, which is determined by the information processing apparatus according to the information sent in said sending step and a predetermined conflict determination condition, from the information processing apparatus; and
a display step of displaying a message according to the determination result received in said reception step.

16. An image forming program causing a computer to execute an image forming method for an image forming apparatus that has image processing functions, forms an image using the image forming functions, and is connectable to an information processing apparatus having image processing functions, the method comprising:
a first selection step of selecting at least one of the image processing functions that the image forming apparatus has;
a second selection step of selecting at least one of the image processing functions that the information processing apparatus has;
a sending step of sending information showing the image processing function selected in said first selection step and the image processing function selected in said second selection step to the information processing apparatus;
a reception step of receiving a determination result, which is determined by the information processing apparatus according to the information sent in said sending step and a predetermined conflict determination condition, from the information processing apparatus; and
a display step of displaying a message according to the determination result received in said reception step.
